(19) United States
(12) Patent Application Publication
(10) Pub. No.: US 2024/0373825 A1
(43) Pub. Date: Nov. 14, 2024

(54) INSTANT CONTROL LEASH APPARATUS, METHOD OF MAKING AND USING THE SAME

(71) Applicant: Sporn Pet Products, Inc., New York, NY (US)

(72) Inventor: Joseph SPORN, New York, NY (US)

(21) Appl. No.: 18/661,474

(22) Filed: May 10, 2024

Related U.S. Application Data
(60) Provisional application No. 63/465,439, filed on May 10, 2023.

(51) Int. Cl. A01K 27/00

(52) U.S. Cl. CPC A01K 27/003

(57) ABSTRACT

An improved leash is capable of being placed in several different optional configurations. In a first configuration the leash may function as a single long leash. In a second configuration the leash may be used to form either a built-in belt (configured to go around the user's waist) or a built-in sash (configured to go over one of the user's shoulders) to allow the user to walk a dog in a hands-free manner. In a third configuration the leash may be used to form a built-in collar. In a fourth configuration, the leash may be used to form either a built-in belt or sash using a belt portion of the leash and a built-in collar using a collar portion of the leash. The optional built-in belt/sash and optional collar are formed by using the material from the leash itself.

### CROSS-REFERENCE TO RELATED APPLICATIONS

This patent application is related to and claims the benefit of U.S. Provisional Patent Application No. 63/465,439 filed on May 10, 2023, titled Instant Control Leash Apparatus, Method of Making and Using the Same, which is hereby fully incorporated by reference.

### FIELD OF THE INVENTION

The present invention relates to an apparatus to be used while walking a dog that has an optional built-in collar and/or allows for hands free walking.

### BACKGROUND

Apparatus specifically designed to control and walk a dog are known. For example, a dog harness is a piece of equipment comprising one or more straps that surround the dog's torso. The harness may be used to control the movements of a dog in a safe and humane manner. The harness may reduce undesirable tension on the neck of the dog while maintaining freedom of movement for the dog. The harness may also be designed to efficiently utilize a dog's pulling power, without hurting the dog.

A leash, sometimes referred to as a lead, lead line or tether, may be attached to the harness and used by a human to guide and control the dog. The leash may be made of one or more different materials, such as rope, leather or chain. The length of the leash controls the maximum distance the dog can be from the human holding the leash. The human may control the movements of the dog through movements of the leash (and possibly voice commands). With practice and training (of both the human and the dog), the human may exercise a great deal of control over the movements of the dog with small and controlled movements of the leash.

### SUMMARY OF THE INVENTION

Accordingly, the invention is directed to a leash that allows a person to walk a dog with an optional built-in belt or sash for hands-free walking and an optional built-in collar that may be used if desired. The built-in belt, sash and collar are created solely from the material of the leash.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

A leash for a person to walk a dog has a belt portion (used to create either an optional belt or sash) having a first terminal end and a second terminal end and a collar portion (used to create an optional collar) having a first terminal end and a second terminal end. The belt portion and collar portions of the leash are separate pieces of material.

The leash may have a belt connector attached to the first terminal end of the belt portion and a collar connector attached to the first terminal end of the collar portion of the leash.

The leash may have a first assembly slidably attached to the belt portion of the leash and configured to be connected to the belt connector. When the belt connector is connected to the first attachment assembly, an optional built-in belt or a sash is formed out of the created loop of material that is configured for a person to wear.

The leash may have a leash length adjuster slidably attached to the leash and configured so that the overall length of the leash may be adjusted when the leash length adjuster slides along the leash.

The leash may have a belt to collar connector to connect the belt portion of the leash with the collar portion of the leash. The belt to collar connector may be an O-ring or a type of buckle suitable to connect two straps of material.

The leash may have a second attachment assembly slidably attached to the collar portion of the leash and configured to be connected to the collar connector. When the collar connector is connected to the second attachment assembly, an optional built-in collar is formed out of the created loop of material that is configured for a dog to wear as a collar.

This Summary section is neither intended to be, nor should be, construed as being representative of the full extent and scope of the present disclosure. Additional benefits, features and embodiments of the present disclosure are set forth in the attached figures and in the description hereinbelow, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of a leash apparatus arranged in accordance with an example embodiment of the present invention;

FIG. 2 is a right side view of the leash apparatus arranged in accordance with an example embodiment of the present invention illustrated in FIG. 1;

FIG. 3 is a left side view of the leash apparatus arranged in accordance with the example embodiment of the present invention illustrated in FIG. 1;

FIG. 4 is a front side view of the leash apparatus arranged in accordance with the example embodiment of the present invention illustrated in FIG. 1;

FIG. 5 is a back side view of the leash apparatus arranged in accordance with the example embodiment of the present invention illustrated in FIG. 1;

FIG. 6 is a top view of the leash apparatus arranged in accordance with the example embodiment of the present invention illustrated in FIG. 1;

FIG. 7 is a bottom view of the co-walk leash apparatus arranged in accordance with the example embodiment of the present invention illustrated in FIG. 1;

FIG. 8 is a perspective view of the leash apparatus arranged illustrating a belt or sash being created when a belt connector is connected to an attachment assembly in accordance with the example embodiment of the present invention illustrated in FIG. 1;

FIG. 9 is a perspective view of the leash apparatus arranged illustrating a collar being created when a collar connector is connected to an attachment assembly in accordance with the example embodiment of the present invention illustrated in FIG. 1; and

FIG. 10 is a flowchart of a possible method of using the leash illustrated in FIGS. 1-9.

### DETAILED DESCRIPTION OF THE ILLUSTRATED EMBODIMENTS

The following detailed description describes a co-walk leash apparatus, method of using and making the same and is presented to enable any person skilled in the art to make and use the disclosed subject matter in the context of one or more particular implementations. Various modifications, alterations, and permutations of the disclosed implementations can be made and will be readily apparent to those skilled in the art, and the general principles defined may be applied to other implementations and applications, without departing from scope of the disclosure. The present disclosure is not intended to be limited to the described or illustrated implementations, but to be accorded the widest scope consistent with the described principles and features.

For the purposes of promoting an understanding of the principles of the present disclosure, reference will now be made to the exemplary embodiments illustrated in the drawing(s), and specific language will be used to describe the same.

Appearances of the phrases an “embodiment,” an “example,” or similar language in this specification may, but do not necessarily, refer to the same embodiment, to different embodiments, or to one or more of the figures. The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise.

In order to more fully appreciate the present disclosure and to provide additional related features, each of the following references are fully incorporated herein by reference in their entirety:

(1) U.S. Pat. No. 7,497,186 discloses an animal self-carried hydrating system comprises an animal harness, a fluid container for holding the fluid, and a fluid dispensing mechanism. The animal harness is securable on the animal by a fastening system. The animal harness has a fluid pocket for holding the fluid container. The fluid dispensing mechanism is attached to the fluid container, in fluid communication with the fluid in the fluid container. The fluid dispensing mechanism is such that it can dispense fluid from the fluid container to the animal while the fluid container is in the fluid pocket.

(2) U.S. Pat. No. 9,241,474 teaches an animal harness for an animal that includes a loop of webbing, which encircles the back, neck and shoulder of the animal. A pouch is affixed to the loop. A pulsating device is disposed within the pouch and transmits same to the animal through the chest and about its heart to calm the animal during transport.

(3) U.S. Pat. No. 6,568,575 discloses a harness with detachable and interchangeable pouches comprises two torso straps extending downwardly and outwardly from a central coupler assembly, two shoulder straps, and two belly straps. The harness is adjustable to fit nearly any body size. The pouches are attached to the harness with quick-releasing retaining clips and to each other by the belly straps. Each pouch includes front and rear panels that are formed using either a right-side template or a left-side template and is interchangeable with any other pouch designed using the same template. The interchangeability allows the wearer to install pouches that are best suited for a particular activity. Each pouch is designed such that, when worn, it hangs at an angle which causes its top to slant downwardly toward the middle of the wearer's torso, thereby increasing the accessibility of the pouch contents.

(4) U.S. Pub. No. 2017/0215385 relates to a novel pet harness and pack for comfortably harnessing a dog and providing a dispenser for waste bags one on side of the harness and a storage pouch on the opposite side. The pouches are colorfully decorated with character faces and the bags will dispense out of a portion of the character's face. A metal loop is provided beneath a cross-stitched reinforced section of fabric wherein a leash may be attached to the harness.

(5) U.S. Pat. App. No. 2022/0079119A1 teaches a retractable leash assembly for a pet animal, such as a dog. The leash assembly includes a casing body with a handle attached to the body by an at least one hinge joint, a braking device, and a spool arrangement with an extendable lead line wound thereabout and configured attachable to the pet animals' collar or harness, wherein in the leash assembly the handle is configured to articulate about the joint with regard to the casing body, the articulation movement of the handle being triggered by the pulling force exerted on the lead line by the animal kept on the leash, and wherein, by virtue of the articulation movement the braking device actuates a braking action causing the lead line to reduce unwinding speed proportionally with an increase in the pulling force.

(6) U.S. publication No. 2022/0167592 relates to a leash extender with a larger round wrist loop and a smaller round handle loop connected by an extension. A user will wrap the leash extender around the handle of a pet leash and pass the wrist loop through the handle loop and pull securely. The leash extender is made of a soft, flexible material and has no edges, so is very comfortable around the user's wrist.

(7) U.S. Pub. No. 2022/0125016 teaches a dog leash that includes a dog leash body. An end of the dog leash body is provided with an annulus structure and forms a traction part. The traction part is provided with a buckle by butt-and-collar joint. The root segment of the traction part is covered with a sheath. The dog leash adapts flexible steel wire rope with good flexibility and high strength. The steel wire rope is coated with plastic layer, which has good touch feeling and high use comfort.

Reference will now be made in detail to an embodiment of the present invention, example of which is illustrated in the accompanying drawings.

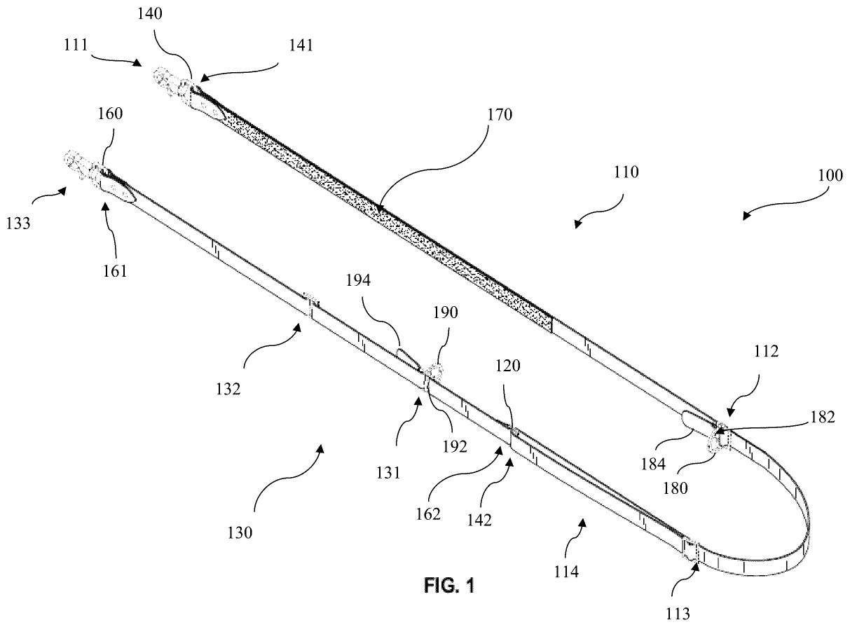

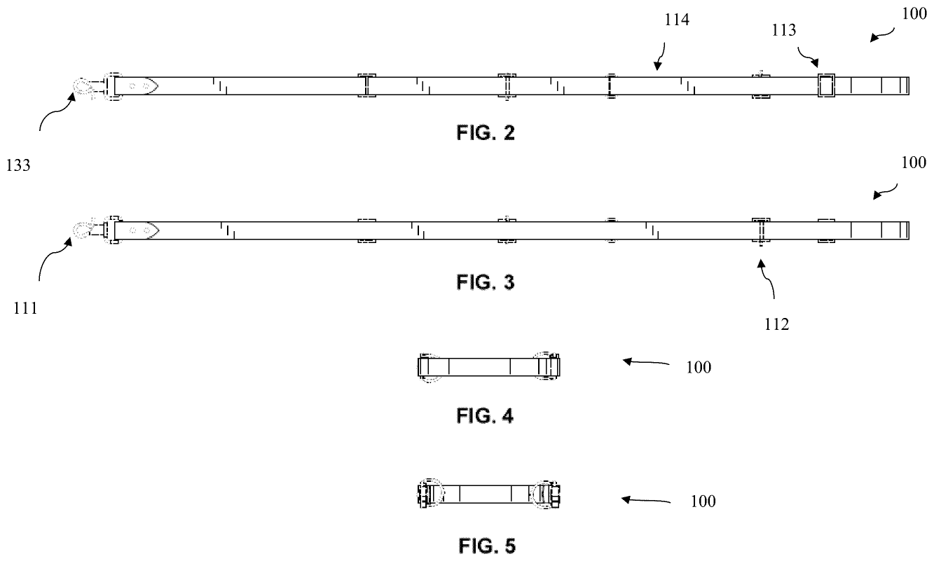

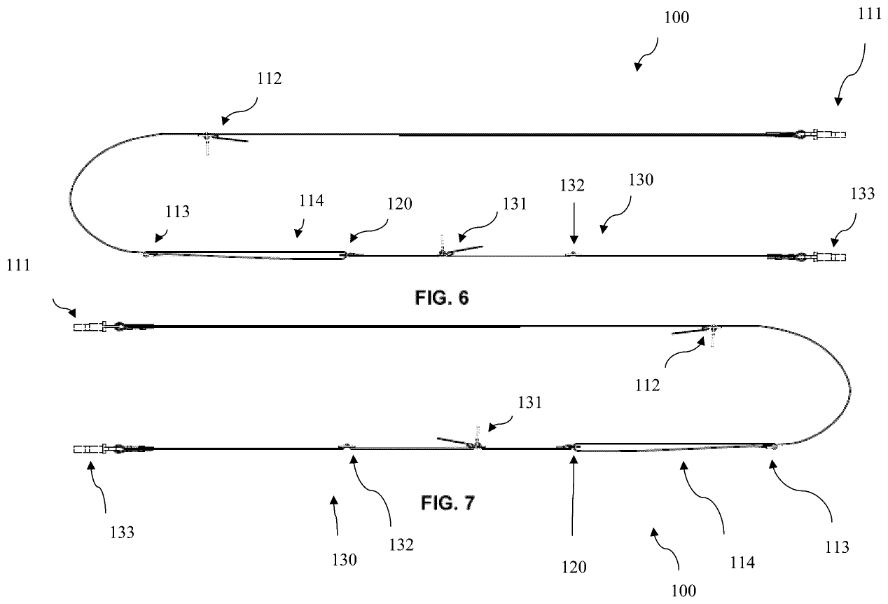

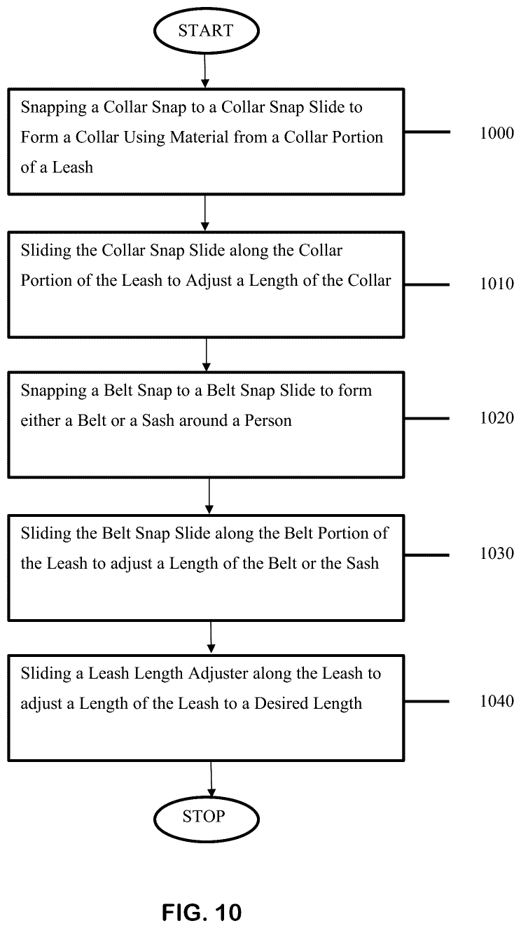

The present invention will now be discussed with reference to FIGS. 1-10, which illustrate various views of a leash 100. The leash 100 is capable of being placed in several different optional configurations. FIGS. 1, 6 and 7 illustrate a first optional configuration where the leash 100 operates as a single long leash without using a built-in belt, built-in sash or built-in collar. In this embodiment, the person using the leash may hold one end of the leash while attaching a collar connector 133 on the other end of the leash 100 to a D-ring or other mating/compatible connector on a collar (not shown and not part of the invention) on a dog. The collar connector 133 may be any device that connects the end of the leash 100 to a collar on a dog. As non-limiting examples, the collar connector 133 may be a hook, clasp, snap or other connecting device.

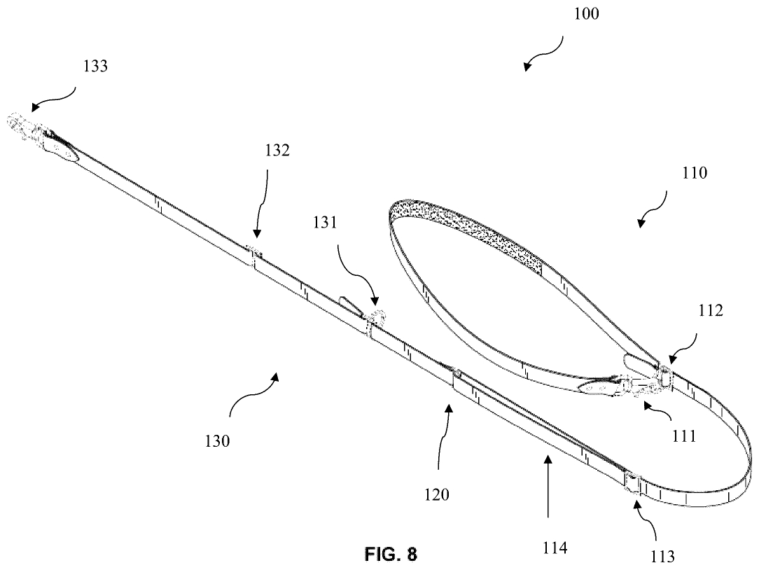

FIG. 8 illustrates a second optional configuration where a belt connector 111 on one end of the leash 100 is connected to an attachment assembly 112 to form either a belt (configured to go around the user's waist) or a sash (configured to go over one of the user's shoulders) out of a first end portion of the leash 100. The attachment assembly 112 may, for example, comprise a buckle 182 (e.g. slip-lock buckle) slidably attached to the belt portion 110, and a D-ring 180 (or other typical stationary buckle) rotatably attached to the sliding buckle. More specifically, the attachment assembly 112 may further comprise a clip attached to the sliding buckle 182 (e.g., to the middle bar of a slip-lock buckle) and retaining the D-ring 180 approximate the buckle while allowing the D-ring 180 to rotate. The attachment assembly 112 may further comprise a pull tab 184, comprising a tactile material such as a fabric or leather strip, attached to the sliding buckle 182 (e.g., to the proximal bar of a slip-lock buckle). The pull tab 184 may be grasped by the user to stabilize the attachment assembly 112 when pulling the leash 100 to slide the attachment assembly 112 along the belt portion 110 (i.e., to loosen or tighten the belt loop).

In this embodiment, the person using the leash 100 may place the belt around the user's waist or the sash over one of the user's shoulders. The process of turning a portion of the leash 100 into a belt, or separately into a sash includes the steps of attaching the collar connector 133 to a collar or harness of the dog, placing the leash around the user's body, and connecting the belt connector 111 to the attachment assembly 112. While the belt is preferably created around the user's body, the sash may be created first and then placed around the user's body. In other embodiments, the belt or sash may be created/worn first and then the belt connector 111 may be connected to the attachment assembly 112. This allows the user to walk the dog in a hands-free manner. In other words the user does not have to use their hands to hold the leash 100 while walking their dog as the leash 100 is attached to the dog using the collar connector 133 and to the user via the built-in belt or the built-in sash.

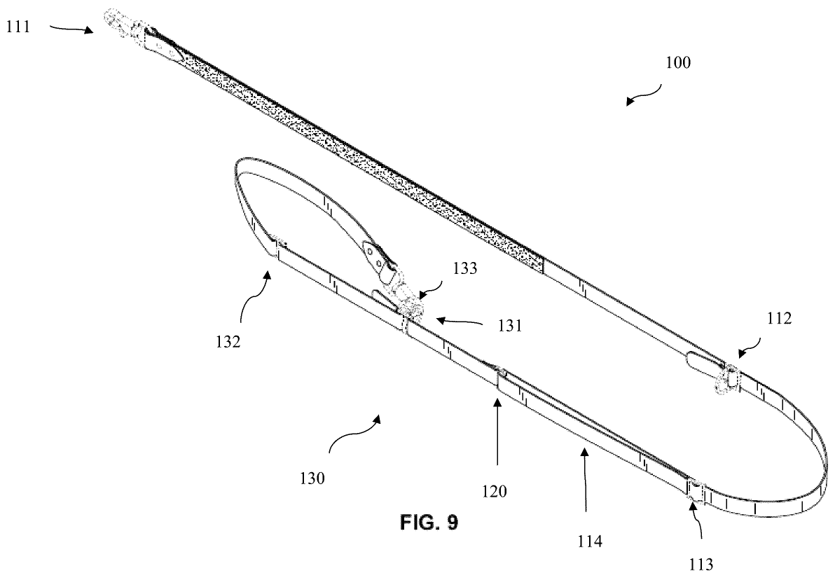

FIG. 9 illustrates a third optional configuration where a collar connector 133 on an end of the leash 100 is connected to an attachment assembly 131 to form a built-in collar out of a collar portion 130 of the leash 100. In this embodiment, the person using the leash 100 may place the collar around the dog's neck or may wrap the strap of the collar portion 130 around the dog's neck and then attach the collar connector 133 to the attachment assembly 131. This allows the user to use the leash 100 as a leash and collar combination if desired.

It should be appreciated that the discussed embodiments may be used in any desired combination. Specifically, the user may use the leash 100 as simply a leash (FIGS. 1, 6 and 7); the user may use the leash 100 as a belt or sash and a leash (FIG. 8); the user may use the leash 100 as a leash and collar (FIG. 9); and the user may use the leash 100 as a belt or sash, leash and collar (not shown together, but a combination of FIGS. 8 and 9).

The leash 100 may include a first portion having a first terminal end 141 and a second terminal end 142 and including the belt portion 110, and a second portion having a first terminal end 161 and a second terminal end 162 and including the collar portion 130. The belt portion 110 preferably comprises a single piece of continuous material and the collar portion 130 preferably comprises a different single piece of material, i.e., there are at least two separate pieces of continuous material. In some embodiments, a part of the belt portion 110 may have a padded backing 170 to improve the comfort to the user wearing the built-in belt or sash made from the leash 100. In some embodiments, a part of the collar portion 130 may have a padded backing (not shown) to improve the comfort to the dog wearing the built-in collar made from the leash 100.

The belt portion 110 and collar portion 130 may be made of the same material or different materials. The belt portion 110 and collar portion 130 may be made of any desired material. As non-limiting examples, the belt portion 110 and collar portion 130 may be made of leather, nylon, chain, rubber, cotton, webbing or any combination thereof. In other embodiments, the belt portion 110 and/or the collar portion 130 are made of a woven narrow fabric made from nylon filament yarns or high tensile polyester filament yarns. In preferred embodiments, the belt portion 110 and collar portion 130 include reflective stitching to provide for added visibility and safety.

The leash 100 may be of any desired length from a distal end of the belt connector 111 to a distal end of the collar connector 133. In preferred embodiments the length from the distal end of the belt connector 111 to the distal end of the collar connector 133 is between five and 14 feet long.

The belt connector 111 and collar connector 133 may be any desired type of connection device. As non-limiting examples, the belt connector 111 and/or collar connector 133 may be any type of snap hook, hook clip, bolt snap, hook, snap, clip or clasp. The belt connector 111 and collar connector 133 may be any desired type of material. As non-limiting examples, the belt connector 111 and/or collar connector 133 are made of metal (such as, as non-limiting examples, iron, steel, stainless steel, aluminum or titanium), 3-D printer ink, resin or hard durable plastic.

The belt connector 111 may be attached to the first terminal end 141 of the belt portion 110, i.e., a first end of the leash 100, by any desired method. The collar connector 133 may be attached to the first terminal end 141 of the collar portion 130, i.e., a second end of the leash 100, by any desired method. The belt connector 111 and collar connector 133 may be attached to the leash 100 by any desired means. The belt connector 111 and collar connector 133 may be attached to the leash 100 by the same means or by different means.

In a preferred embodiment of attaching the belt connector 111 to the first terminal end 141 of the leash 100, the belt portion 110 is laced through a D-ring 140, folded back on itself either stitched or riveted to itself, thereby retaining the D-ring 140 at the first terminal end 141 of the leash 100. The belt connector 111 may be attached to the D-ring 140 by any desired means. As non-limiting examples, the belt connector 111 may be attached to the D-ring 140 by welding or by using a screw, bolt, rivet, snap hook, hook clip, bolt snap, hook, snap, clip, or clasp. In preferred embodiments, the D-ring 140 may rotate around a first axis and the belt connector 111 may spin while connected to the D-ring 140 in a second axis. In a preferred embodiment, the first axis of rotation of the D-ring 140 is different from the second axis of the belt connector 111 spinning. In a most preferred embodiment, the first axis of rotation of the D-ring 140 is perpendicular to the second axis of the belt connector 111 spinning.

In a preferred embodiment of attaching the collar connector 133 to the other terminal end 161 of the leash 100, the collar portion 130 is laced through a D-ring 160, folded back on itself and either stitched or riveted to itself, thereby retaining the D-ring 160 at the terminal end 161 of the collar portion 130. The collar connector 133 may be attached to the D-ring 160 by any desired means. As non-limiting examples, the collar connector 133 may be attached to the D-ring 160 by welding or by using a screw, bolt, rivet, snap hook, hook clip, bolt snap, hook, snap, clip, or clasp. In preferred embodiments, the D-ring 160 may rotate around a first axis and the collar connector 133 may spin while connected to the D-ring 160 in a second axis. In a preferred embodiment, the first axis of rotation of the D-ring 160 is different from the second axis of the collar connector 133 spinning. For example, the first axis of rotation of the D-ring 160 can be perpendicular to the second axis of the collar connector 133 spinning.

A first attachment assembly 112 may be attached to the belt portion 110 of the leash 100 such that the first attachment assembly 112 may slide to different positions on the belt portion 110 of the leash 100. The first attachment assembly 112 may be of any desired design. As a non-limiting example, the first attachment assembly 112 may have a buckle and a D-ring 180. The buckle may have a front opening, a middle post and a back opening that allows the belt portion 110 of the leash 100 to be laced up the front opening, over the middle post and down the back opening of the buckle. The D-ring 180 may be connected or attached to or near the middle post of the buckle. The first attachment assembly 112 may be made of metal (such as, as non-limiting examples, iron, steel, stainless steel, aluminum or titanium), 3-D printer ink, resin, hard durable plastic or some combination thereof. In a preferred embodiment, the belt connector 111 is removably attachable to the D-ring 180 of the attachment assembly 112.

The first attachment assembly 112 may be configured to be connected to the belt connector 111 by any desired means. When the belt connector 111 is connected to the first attachment assembly 112, the belt portion 110 forms a loop that can serve as either a belt or a sash that a person may wear either around the waist of the user (belt) or around a shoulder of the user (sash). The first attachment assembly's 112 position on the belt portion 110 of the leash 100 may be changed to change the size of the built-in optional belt or built-in optional sash. For example, the user may grip the pull tab 184 in one hand and the belt portion 110 in the other hand (on the proximal/belt side to loosen and the distal end to tighten) and pulls the belt portion 110.

An attachment assembly 131 may be attached to the collar portion 130 of the leash 100 such that the attachment assembly 131 may slide to different positions on the collar portion 130 of the leash 100. The attachment assembly 131 may be of any desired design. As a non-limiting example, the attachment assembly 131 may have a buckle 192 and a D-ring 190. The buckle 192 may have a front opening, a middle post and a back opening that allows the collar portion 130 of the leash 100 to be laced up the front opening, over the middle post and down the back opening of the buckle 192. The D-ring 190 may be rotatably connected or attached to or near the middle post of the buckle 192. The attachment assembly 131 may further comprise a pull tab 194, comprising a tactile material such as a fabric or leather strip, attached to the sliding buckle 192 (e.g., to the proximal bar of a slip-lock buckle). The pull tab 194 may be grasped by the user to stabilize the attachment assembly 131 when pulling the leash 100 to slide the attachment assembly 131 along the collar portion 130 (i.e., to loosen or tighten the collar loop). The attachment assembly 131 may be made of metal (such as iron, steel, stainless steel, aluminum or titanium), 3-D printer ink, resin, hard durable plastic or some combination thereof. In a preferred embodiment, the collar connector 133 is removably attachable to the D-ring 190 of the attachment assembly 131.

Also, as illustrated, the collar portion 130 threads through the attachment assembly 131 the same way as the belt portion 110, and permanently attaches to the belt to collar connector 120. The attachment assembly 131 is adjusted as described above to adjust the size of the collar. The attachment assembly 131 may be configured to be connected to the collar connector 133 by any desired means. When the collar connector 133 is connected to the attachment assembly 131, a loop of material from the collar portion 130 is formed creating a built-in collar that a dog may wear around its neck. The attachment assembly 131 position on the collar portion 130 of the leash 100 may be changed to change the size of the built-in dog collar. A collar length adjuster 132 may be positioned on the collar portion 130 between the attachment assembly 131 and the second terminal end 161 of the leash 100 and may be configured to arrest the sliding movement of the attachment assembly 131. In this manner, the collar length adjuster 132 may be used to set a minimum diameter for the built-in collar, so that the collar cannot be made smaller than a minimum desired diameter to prevent strangling the dog.

In an alternate, not-illustrated embodiment, the collar strap length may be adjustable using the collar length adjuster 132 as follows: the collar strap threads through the apertures of 132 as illustrated, extends through the closest aperture of the attachment assembly 131, and overlaps back on itself, attaching to the middle bar of the collar length adjuster 132. In this embodiment, the belt to collar connector 120 is omitted, and the belt portion 110 extends through the other aperture of the attachment assembly 131 and loops back on itself to attach to 113 as described below.

The attachment assembly 112 for forming the belt and the attachment assembly 131 for forming the collar may have an outer frame that is either square or rectangular. The attachment assemblies 112, 131 may have zero, one, two or more parallel posts positioned inside the outer frame. These shapes allow the attachment assemblies 112, 131 to be easily slid along portions of the belt portion 110 and the collar portion 130, respectively, by loosening the belt portion 110 or collar portion 130 inside the corresponding attachment assembly 112, 131, yet once in place, the belt portion 110 or collar portion 130 may be tightened in the corresponding attachment assembly 112, 131 to firmly hold the attachment assembly 112, 131 to its current position.

A leash length adjuster 113, which may be, as a non-limiting example, a tri-glide or similar collar length adjuster, may be slidably attached to the leash 100 such that the leash length adjuster 113 may slide to different positions on the leash 100. The leash length adjuster 113 may be of any desired design and may use any desired means to adjust the length of the leash 100. In some embodiments, the leash length adjuster 113 may be slid by the user along the leash 100 where the leash length adjuster 113 is attached, which changes the length of an overlapping portion 114, formed as described below, to correspondingly change the length of the leash 100. As a non-limiting example, the leash length adjuster 113 may have a buckle having a front opening, a middle post and a back opening that allows the leash 100 to be laced up the front opening, over the middle post and down the back opening of the buckle. The leash length adjuster 113 in some embodiments may give the leash 100 an adjustability between four feet and seven feet.

The leash length adjuster 113 may be made of metal (such as, as non-limiting examples, iron, steel, stainless steel, aluminum or titanium), 3-D printer ink, resin, hard durable plastic or some combination thereof.

The belt portion 110 of the leash 100 may be connected to the collar portion 130 of the leash 100 by any desired means. As a non-limiting example, a belt to collar connector 120 may be used to connect the belt portion 110 of the leash 100 to the collar portion 130 of the leash 100. The belt to collar connector 120 may be an O-ring or a D-ring. In other embodiments, the belt to collar connector 120 may be a buckle having a collar opening and a belt opening. In another embodiment, the belt to collar connector 120 may have a collar opening, a belt opening and a middle post. The belt to collar connector 120 may be made of metal (such as, as non-limiting examples, iron, steel, stainless steel, aluminum or titanium), 3-D printer ink, resin, hard durable plastic or some combination thereof. The belt to collar connector120 may use any desired means to connect the belt portion 110 of the leash 100 with the collar portion 130 of the leash 100.

As a non-limiting example, the belt to collar connector 120 may be a slip-lock or similar buckle having a belt opening, a center post and a collar opening. The second terminal end 142 of the belt portion 110 may be threaded through the belt opening and attached to the leash length adjuster 113 (e.g., to the center post or middle bar of a slip-lock buckle) to form the overlapping portion 114, so that the overall length of the leash 100 is adjusted when the leash length adjuster 113 slides along the belt portion 110 of the leash 100. For example, sliding the leash length adjuster 113 toward the collar portion 130 shortens the overlapping portion 114 and lengthens the amount of leash 100 between the respective ends, and sliding the leash length adjuster 113 the opposite direction has the opposite effects.

In a preferred embodiment, the second terminal end 142 of the belt portion 110 of the leash 100 is attached to the middle post of the buckle of the leash length adjuster 113. The second terminal end 142 of the belt portion 110 of the leash 100 may be attached to the middle post of the buckle by any desired means. In a preferred embodiment of attaching the second terminal end 142 of the belt portion 110 of the leash 100 to the middle post of the buckle of the leash length adjuster 113, the second terminal end 142 of the belt portion 110 is laced up the front opening, over the middle post and down the back opening of the buckle. The second terminal end 142 of the belt portion 110 is folded back on itself and the second terminal end 142 of the belt portion 110 is either stitched or riveted to itself, thereby attaching the second terminal end 142 of the belt portion 110 of the leash 100 to the leash length adjuster 113.

The second terminal end 162 of the collar portion 130 may be threaded through the collar opening, overlapped with itself and attached to itself by any desired means. As non-limiting examples, the second terminal end 162 of the collar portion 130 may be attached to itself using one, two, three or more rivets and/or by stitching thereby connecting the second terminal end 162 of the collar portion 130 to the belt to collar connector 120. This process results in the enclosing, trapping and retaining of the collar opening of the buckle (or more broadly, with the belt to collar connector 120) with a loop of material from the collar portion 130.

A leash 100 for a person to walk a dog has a belt portion 110 (used to create either an optional built-in belt or an optional built-in sash) having a first terminal end 141 and a second terminal end 142 and a collar portion 130 (used to create an optional built-in collar) having a first terminal end 161 and a second terminal end 162. The belt portion 110 and collar portion 130 of the leash are separate pieces of material.

The leash 100 may have a belt connector 111 attached to the first terminal end 141 of the belt portion 110 and a collar connector 133 attached to the first terminal end 161 of the collar portion 130 of the leash 100. The leash may have a first attachment assembly 112 slidably (preferably including a D-ring) attached to the belt portion 110 of the leash 100 and configured to be connected to the belt connector 111. When the belt connector 111 is connected to the first attachment assembly 112, an optional built-in belt or a built-in sash is formed out of the created loop of material from the belt portion 110 that is configured for a person to wear.

The leash 100 may have a leash length adjuster 113 slidably attached to the leash 100 and configured with the belt portion 110 of the leash 100 so that the overall length of the leash 100 may be adjusted (shortened or lengthened) when the leash length adjuster 113 slides along the leash 100.

The leash 100 may have a belt to collar connector 120 to connect the belt portion 110 of the leash 100 with the collar portion 130 of the leash 100. The belt to collar connector 120 may be an O-ring or a type of buckle suitable to connect two straps of material, such as the belt portion 110 and the collar portion 130.

The leash 100 may have an attachment assembly 131, preferably having a D-ring 190, slidably attached to the collar portion 130 of the leash 100 and configured to be connected to the collar connector 133. When the collar connector 133 is connected to the attachment assembly 131, an optional built-in collar is formed out of the created loop of material from the collar portion 130 of the leash 100 that is configured for a dog to wear as a collar. The size of the optional built-in collar may be any desired size, based on the length of the collar portion 130 of the leash 100. In a preferred embodiment, the collar may be adjusted up to 22 inches.

In some embodiments, the leash 100 may also have a collar length adjuster 132 attached to the collar portion 130 of the leash 100. The collar length adjuster 132 may adjust the length of the collar portion 130 of the leash 100 by any desired method, such as by the method described for the leash length adjuster 113 previously described.

In another embodiment, a method is provided for a person to walk a dog using a leash 100. The person may snap a collar connector 133 to an attachment assembly 131 to form a collar around a neck of the dog using material from a collar portion 130 of the leash 100. (Step 1000) The person may slide the attachment assembly 131 along the collar portion 130 of the leash 100 to adjust a length of the collar to be appropriate for a size of the neck of the dog. (Step 1010) The person may snap a belt connector 111 to an attachment assembly 112 to form either a belt or a sash around the person walking the dog using material from a belt portion 110 of the leash 100. (Step 1020) The person may slide the attachment assembly 112 along the belt portion 110 of the leash 100 to adjust a length of the belt or the sash to be appropriate for a size of the person walking the dog. (Step 1030) The person may then slide a leash length adjuster 113 along the leash 100 to adjust a length of the leash 100 to a desired length. It should be appreciated that while this is a preferred sequence for the steps to be performed, other sequences of steps may also be used.

The inventions and methods described herein can be viewed as a whole, or as a number of separate inventions, that can be used independently or mixed and matched as desired. All inventions, steps, processed, devices, and methods described herein can be mixed and matched as desired. All previously described features, functions, or inventions described herein or by reference may be mixed and matched as desired.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A leash for a person to walk a dog, comprising:
a belt portion of the leash having a first terminal end and a second terminal end;
a collar portion of the leash, different from the belt portion of the leash, having a first terminal end and a second terminal end,
a belt connector attached to the first terminal end of the belt portion;
a first attachment assembly slidably attached to the belt portion of the leash and configured to be connected to the belt connector;
a leash length adjuster slidably attached to the belt portion;
a belt to collar connector having a belt opening and a collar opening,
a collar connector attached to the first terminal end of the collar portion; and
a collar connector attachment assembly slidably attached to the collar portion of the leash and configured to be connected to the collar connector.

2. The leash of claim 1, wherein when the belt connector is connected to the first attachment assembly, the belt portion forms one or both of a belt and a sash configured for the person to wear.

3. The leash of claim 2, wherein the second terminal end of the belt portion is threaded through the belt opening and the second terminal end of the belt portion is overlapped with itself and attached to the leash length adjuster so that an overall length of the leash is adjusted when the leash length adjuster slides along the leash.

4. The leash of claim 3, wherein the second terminal end of the collar portion is threaded through the collar opening of the belt to collar connector and the second terminal end of the collar portion is overlapped with itself and attached to itself, thereby attaching the second terminal end of the collar portion to the belt to collar connector.

5. The leash of claim 4, wherein when the collar connector is connected to the collar connector attachment assembly, the collar portion forms a collar configured for the dog to wear.

6. The leash of claim 5, wherein the first attachment assembly comprises a D-ring that receives the belt connector.

7. The leash of claim 6, wherein the collar connector attachment assembly further comprises a buckle, the D-ring rotatably attached to the buckle and the belt portion slidably attached to the buckle.

8. The leash of claim 1, wherein the belt connector is fixedly attached to the first terminal end of the belt portion of the leash.

9. The leash of claim 1, wherein the collar connector is fixedly attached to the first terminal end of the collar portion of the leash and is configured to attach the leash to a separate collar on the dog.

10. The leash of claim 1, wherein the leash length adjuster allows the length of the leash to be adjustable between four and seven feet.

11. A leash for a person to walk a dog, comprising:
a belt portion of the leash having a first terminal end and a second terminal end;
a collar portion of the leash, different from the belt portion of the leash, having a first terminal end and a second terminal end;
a belt connector attached to the first terminal end of the belt portion;
a first attachment assembly slidably attached to the belt portion of the leash and configured to be connected to the belt connector;
a leash length adjuster slidably attached to the leash and configured to allow an overall length of the leash to be adjusted based on a position of the leash length adjuster on the leash;
a belt to collar connector configured to connect the belt portion of the leash with the collar portion of the leash;
a collar connector attached to the first terminal end of the collar portion; and
a second attachment assembly slidably attached to the collar portion of the leash and configured to be connected to the collar connector.

12. The leash of claim 11, wherein when the belt connector is connected to the first attachment assembly, a belt or a sash is formed from a material of the belt portion of the leash that is configured for a person to wear.

13. The leash of claim 12, wherein when the collar connector is connected to the second attachment assembly, a collar is formed from the material of the collar portion of the leash that is configured for a dog to wear as a collar.

14. The leash of claim 13, wherein the first attachment assembly comprises a D-ring.

15. The leash of claim 13, wherein the second attachment assembly comprises a D-ring.

16. The leash of claim 13, wherein the belt connector is fixedly attached to the first terminal end of the belt portion of the leash.

17. The leash of claim 13, wherein the collar connector is fixedly attached to the first terminal end of the collar portion of the leash.

18. The leash of claim 13, wherein the leash length adjuster is a tri-glide buckle that allows the length of the leash to be adjustable between four and seven feet.

19. A method of walking a dog using a leash, comprising the steps of:
snapping a collar connector to a second attachment assembly to form a collar around a neck of a dog using material from a collar portion of the leash;
sliding the second attachment assembly along the collar portion of the leash to adjust a length of the collar to be appropriate for a size of the neck of the dog;
snapping a belt connector to a first attachment assembly to form either a belt or a sash around a person walking the dog using material from a belt portion of the leash; and
sliding the first attachment assembly along the belt portion of the leash to adjust a length of the belt or the sash to be appropriate for a size of the person walking the dog.

20. The method of claim 19, further comprising the step of:
sliding a leash length adjuster along the leash to adjust a length of the leash to a desired length.
